(19) United States
(12) Patent Application Publication
(10) Pub. No.: US 2014/0163860 A1
(43) Pub. Date: Jun. 12, 2014

(54) MANAGING AND DIRECTING MASS TRANSIT SYSTEM PASSENGERS

(71) Applicant: INTERNATIONAL BUSINESS MACHINES CORPORATION, Armonk, NY (US)

(72) Inventors: Alessandro L. Chiantera, Roma (IT); Francesca Curzi, Roma (IT); Ilaria Gorga, Roma (IT); Stefania B. Stasi, Roma (IT)

(73) Assignee: International Business Machines Corporation, Armonk, NY (US)

(21) Appl. No.: 13/709,650

(22) Filed: Dec. 10, 2012

(51) Int. Cl. G01C 21/00

(52) U.S. Cl. CPC G01C 21/00
USPC 701/400

(57) ABSTRACT

A method for managing mass transit system passengers. The method includes identifying, by a computing system of a mass transit system, a mass transit passenger entering a station of the mass transit system. The method includes receiving an entry time and day, and a location of the station entered by the identified passenger. The method includes determining, for the identified passenger, a location of an exit station, and a route between the station entered and the exit station. The method further includes determining, for the identified passenger, an available seat on a mass transit transporter of the mass transit system for the route.

### FIELD OF THE INVENTION

The present invention relates generally to the field of mass transit systems, and more particularly to managing and directing mass transit system passengers.

### BACKGROUND OF THE INVENTION

Often, management and control of mass transit systems cannot keep up with the growth in passenger traffic. Traffic peaks occur daily during work commutes, during bad weather, or during sporting and other events drawing large crowds. Traffic peaks can lead to bottlenecks and potential breakdowns in the system. Often with mass transit systems, even if a waiting passenger is relatively certain that a train will arrive on time, the passenger may not be certain that a seat will be available when the train arrives, or after any other waiting passengers in a line in front of the passenger have boarded. Frequently, passengers only board a subway car or train at a few locations, for example, in the vicinity of access points such as escalators or stairs, leaving some doors of the train unused. Passengers are likely to avoid traveling any distance to another door because it is unknown whether the car further down has available seats. The length of time for a train to remain in a station is short and drivers do not wait until individual passengers have boarded. Therefore, the majority of passengers prefer to board at the door closest to them, rather than using a door further away and taking the risk there will be no available seats. Additionally, in the case of trains that do no have an internal passageway, the occupancy of each car is irregular, and passengers are crowded in one part of the train, when other cars remain empty or less occupied.

### SUMMARY

Embodiments of the present invention disclose a method, computer program product, and computer system for managing mass transit system passengers. The method includes identifying, by a computing system of a mass transit system, a mass transit passenger entering a station of the mass transit system. The method includes receiving, from the computing system, an entry time and day, and a location of the station entered by the identified passenger. The method includes determining, by the computing system, for the identified passenger, a location of an exit station, and a route between the location of the station entered and the location of the exit station. The method further includes determining, by the computing system, for the identified passenger, an available seat on a mass transit transporter of the mass transit system for the route.

### BRIEF DESCRIPTION OF THE SEVERAL VIEWS OF THE DRAWINGS

FIG. 1 is a functional block diagram illustrating a passenger management environment, in accordance with an embodiment of the present invention.

FIG. 2 is a flowchart depicting operational steps of a passenger management program, for directing passengers to available seats in a mass transit system, in accordance with an embodiment of the present invention.

FIG. 3 depicts an exemplary historical data table, which may be used by the passenger management program of FIG. 2, in accordance with an embodiment of the present invention.

FIG. 4 depicts a block diagram of components of the server computer of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

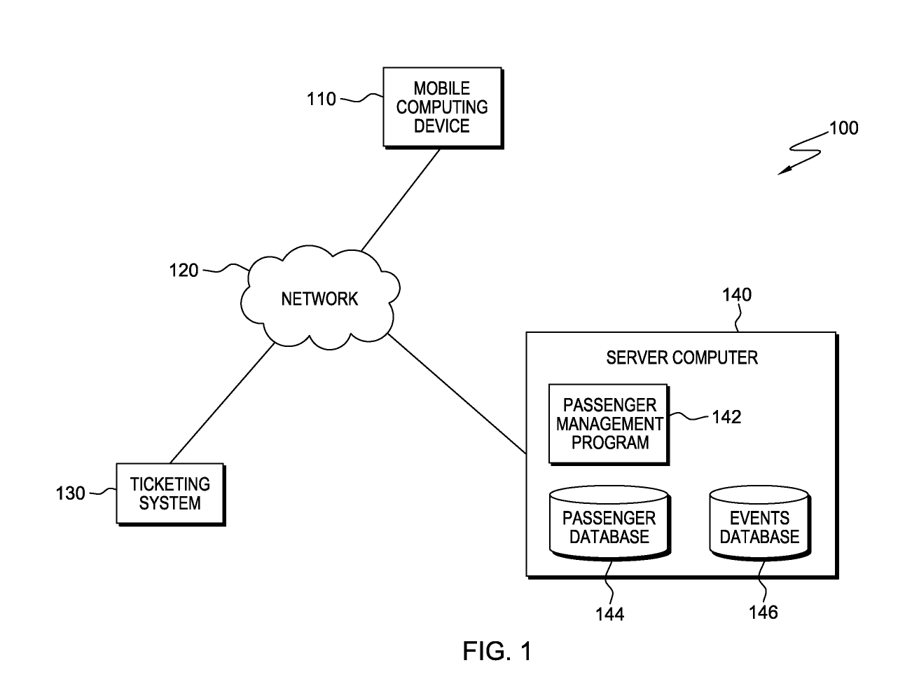

The present invention will now be described in detail with reference to the Figures. FIG. 1 is a functional block diagram illustrating a mass transit passenger management environment, generally designated 100, in accordance with an embodiment of the present invention.

Passenger management environment 100 includes mobile computing device 110, ticketing system 130, and server computer 140, all interconnected over network 120.

In various embodiments of the present invention, mobile computing device 110 can be a laptop computer, a tablet computer, a notebook computer, a personal digital assistant (PDA), a smart phone, or any programmable electronic device capable of communicating with server computer 140 via network 120.

Network 120 can be, for example, a local area network (LAN), a wide area network (WAN) such as the Internet, or a combination of the two, and can include wired, wireless, or fiber optic connections. In general, network 120 can be any combination of connections and protocols that supports communications between mobile computing device 110, ticketing system 130 and server computer 140.

Ticketing system 130 includes both a machine with a display screen or other computing system for ticket purchases, reservation confirmations, and itinerary information displays, and a gate, a machine, a turnstile or any other means through which passengers may pass to enter and/or exit each mass transit station. Ticketing system 130 tracks passengers entering and exiting each station with, for example, a computing system featuring a card swipe, a sensor, a scanner, or any other technology which can track a passenger's passage using a magnetic strip or sensor on a ticket or card.

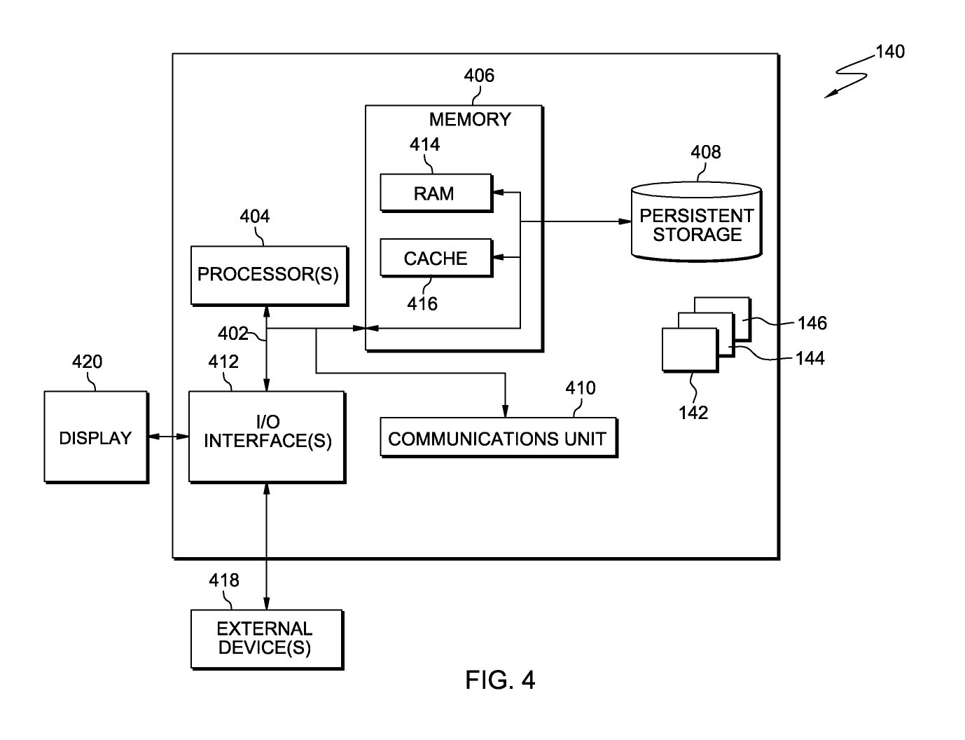

Server computer 140 can be a laptop computer, a tablet computer, a notebook computer, a personal computer (PC), a desktop computer, a handheld computing device or smart phone, a thin client, or any other programmable electronic device capable of executing machine-readable instructions and communicating with mobile computing device 110 and ticketing system 130 via network 120. Server computer 140 may represent a computing system utilizing clustered computers and components to act as a single pool of seamless resources when accessed through a network. This is a common implementation for data centers and for cloud computing applications. Server computer 140 may include internal and external hardware components, as depicted and described in further detail with respect to FIG. 4. Server computer 140 includes passenger management program 142, passenger database 144 and events database 146.

Passenger management program 142 uses information received from ticketing system 130 and retrieved from passenger database 144 and events database 146 to determine an available seat for a passenger and to direct the passenger to the car containing the available seat, through the use of, for example, the passenger's mobile computing device or the display screen included with ticketing system 130. Information retrieved can be, for example, a passenger's historical, routine data for a specific day of the week, a scheduled sporting event, concert, or a weather condition impacting the amount of people that may use the mass transit system on a given day, or daily passenger capacity data used to direct a one-time user to an available seat.

Passenger database 144 stores information for each passenger entering and exiting a mass transit station. For example, information stored for a passenger entering a station can be an entry time, day, date and station location. Upon the passenger's exit, the exit time and station can be stored in passenger database 144. Passenger database 144 contains historical data for regular users, static information about each train in the system, for example, number of cars and number of seats per car, and daily data about all passengers using the mass transit system, including the number of passengers, entrance and exit locations, and times. The daily data, both for regular users and for all passengers, is added to historical data storage at the end of each day. Passenger management program 142 updates passenger database 144 with dynamic seat information each time a recommendation for an available seat is sent to a passenger, and then when the passenger exits a mass transit station. While in FIG. 1, passenger database 144 is shown as located on server computer 140, one of skill in the art will appreciate that passenger database 144 may be located on a storage device accessible to server computer 140 via network 120.

Events database 146 stores calendar information, such as holidays, sporting events, festivals, concerts, and other events that may draw large amounts of people to one or a few select areas, and therefore having an impact on the number and density of passengers using a mass transit system. While in FIG. 1, events database 146 is shown as located on server computer 140, one of skill in the art will appreciate that events database 146 may be located on a storage device accessible to server computer 140 via network 120.

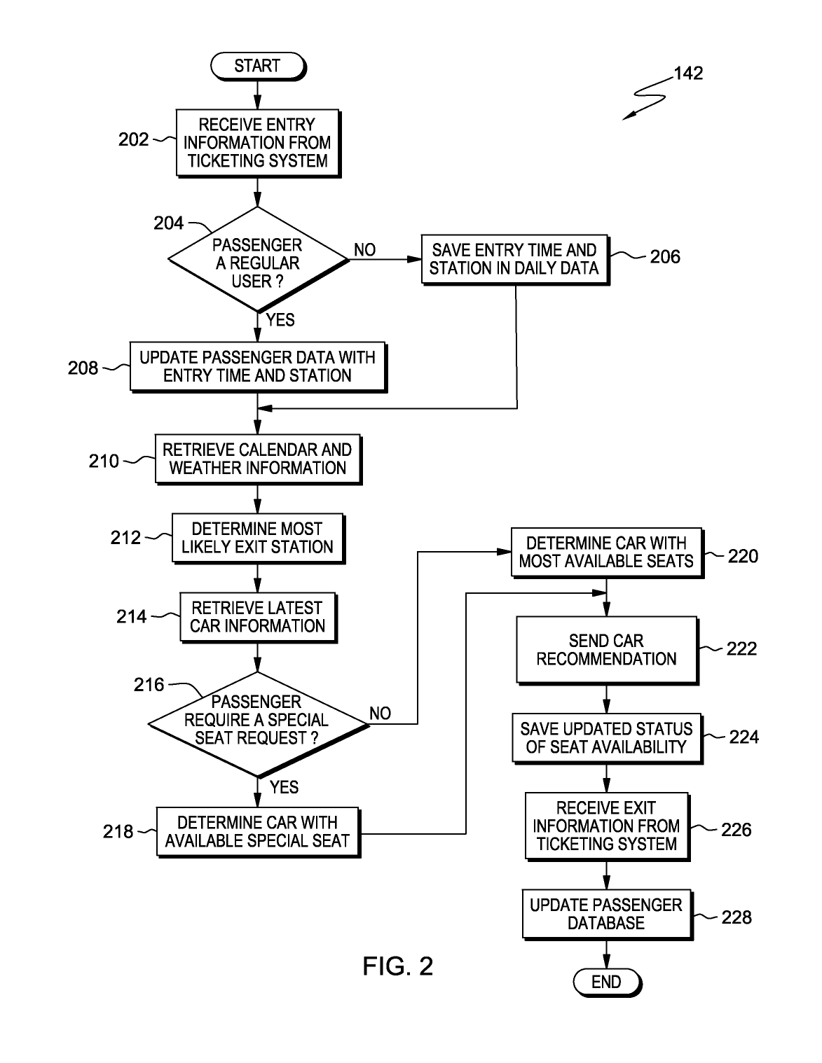

FIG. 2 is a flowchart depicting operational steps of passenger management program 142, for directing passengers to available seats in a mass transit system, in accordance with an embodiment of the present invention.

Passenger management program 142 receives entry information from ticketing system 130 (step 202). Ticketing system 130 can track passengers entering and exiting each station using tracking technology, for example magnetic strips located on travel tickets containing passenger information such as a passenger's itinerary, and a card swipe machine, and send the information to passenger management program 142.

Passenger management program 142 determines whether the entering passenger is a regular user of the transportation system (decision block 204). Passenger management program 142 recognizes a regular user as a passenger who maintains a travel or identification card and an associated account with the mass transit system. If the entering passenger is not a regular user (decision block 204, no branch), passenger management program 142 saves the entry time and station as daily data in passenger database 144 (step 206). Daily data contains information, such as entrance and exit locations, for all passengers each day, including regular users, occasional users and one-time users.

If the entering passenger is a regular user of the transportation system (decision block 204, yes branch), passenger management program 142 updates the passenger's historical data stored in passenger database 144 with the entry time and station location (step 208).

Passenger management program 142 retrieves calendar and weather information (step 210). Calendar information is stored in events database 146 and may include scheduled sporting events or festivals. Weather information can be stored in events database 146 and may include predicted forecasts for each day and season, or can be updated with real-time weather data through a weather application via network 120 or included on server computer 140 (not shown).

Passenger management program 142 determines the most likely exit station for the passenger (step 212). For a regular user, passenger management program 142 can determine the most likely exit station based on historical data. For a one-time user, passenger management program 142 may base the determination on calendar events and weather, daily data, and can use historical data as well. For example, events database 146 may include a football game for a specific Saturday. On that Saturday, daily data may show a large number of passengers exiting at a certain station near an arena and passenger management program 142 may determine the most likely exit station for a one-time user is the station near the arena.

Passenger management program 142 retrieves the latest car information (step 214). Passenger database 144 contains static information and dynamic information for each mass transit system transporter, for example, a train or subway car, compartment, or coach, in the mass transit system. Static information includes data such as the number of cars in a train, the number of seats per car and the number of special seats available. Special seats can include, for example, handicap accessible seats or seating areas for passengers with bicycles or strollers. Dynamic information is updated by passenger management program 142 each time a recommendation for an available seat is sent to a passenger and includes the availability of all seats, including special seats.

Passenger management program 142 determines whether a passenger requires a special seat (decision block 216). If a regular user is known to require a special seat, based on maintained account information, or a passenger enters a request for a special seat when purchasing a ticket or making a reservation (decision block 216, yes branch), passenger management program 142 determines a car with an available special seat based on static and dynamic information for each car, and daily data included in passenger database 144 (step 218). Passenger management program 142 proceeds to send the determined car recommendation to the passenger (step 222).

If a passenger does not require a special seat (decision block 216, no branch), passenger management program 142 determines the car with the most available seats (step 220). Passenger management program 142 determines available seats based on daily data of the number of passengers using the mass transit system and each passenger's most likely route, including exit station, dynamic information updated with previous seat recommendations, and static information regarding each car in the mass transit system.

Passenger management program 142 sends the determined car recommendation to the passenger (step 222). In a preferred embodiment, each regular user includes, within maintained account information, a mobile computing device. Passenger management program 142 can send the determined car recommendation to the included mobile computing device. For a one-time or occasional user, a passenger can receive the determined car information when purchasing a ticket, for example, on a display screen at ticketing system 130.

Passenger management program 142 saves the updated status of seat availability in passenger database 144 (step 224). When a recommendation is sent to a passenger's mobile computing device or displayed at ticketing system 130, passenger management program 142 updates passenger database 144 with the status of available seats, including special seats.

Passenger management program 142 receives exit information from ticketing system 130 (step 226). Ticketing system 130 tracks passengers exiting mass transit stations and sends the information to passenger management program 142. Passenger management program 142 then updates the stored data, both a regular user's historical data and daily data for all passengers, in passenger database 144 with the exit time and station location (step 228). Daily data is updated in order to maintain an accurate count of passengers using the mass transit system at any given time.

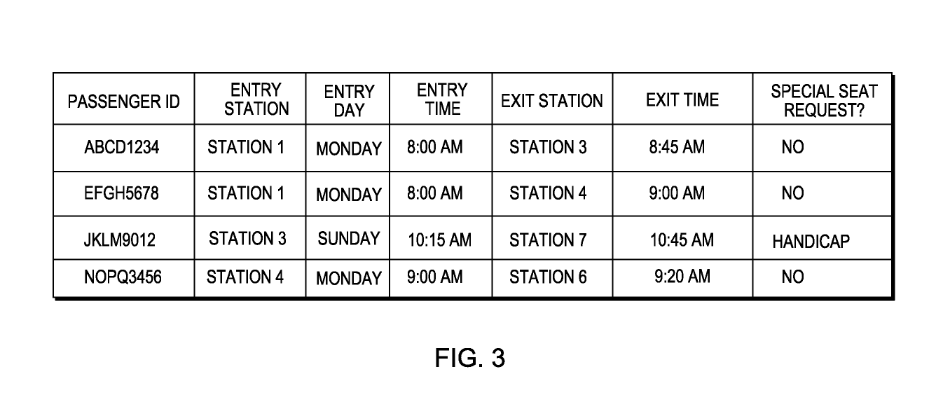

FIG. 3 depicts an exemplary historical data table, which can be stored in passenger database 144 and used by passenger management program 142, in accordance with an embodiment of the present invention. Historical data is maintained for regular users and includes information such as a passenger's entry and exit time, date and station location, as shown in FIG. 3. Passenger management program 142 uses historical data, along with daily data for all passengers, static information for all cars and seats, and updated dynamic information for available seats, to recommend available seats to regular users based on the passenger's most likely exit. For example, if Passenger JKLM9012 enters Station 3 on a Sunday at 10:15 am, passenger management program 142 can recommend a car based on the status of available special seats between Station 3 and Station 7.

FIG. 4 depicts a block diagram of components of server computer 140 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Server computer 140 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Passenger management program 142, passenger database 144 and events database 146 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including mobile computing device 110. In these examples, communications unit 410 includes one or more network interface cards. Communications unit 410 may provide communications through the use of either or both physical and wireless communications links. Passenger management program 142 may be downloaded to persistent storage 408 through communications unit 410.

I/O interface(s) 412 allows for input and output of data with other devices that may be connected to server computer 140. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., passenger management program 142, passenger database 144 and events database 146, can be stored on such portable computer-readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for managing mass transit system passengers, the method comprising the steps of:
identifying, by a computing system, a mass transit passenger entering a station of a mass transit system;
identifying, by the computing system, an entry time and day, and a location of the station the identified passenger is entering;
retrieving historical data for the identified passenger;
retrieving event information for the entry time and day, the event information including calendar and weather information;
determining, by the computing system, for the identified passenger, based, at least in part, on at least one of the historical data and the event information, a location of an exit station;
determining, by the computing system, for the identified passenger, a route between the location of the entered station and the location of the exit station; and
determining, by the computing system, for the identified passenger, based, at least in part, on one or more of the entry time and day, the determined exit station, the historical data, the event information, and the determined route, an available seat on a mass transit transporter of the mass transit system for the route.

2. The method of claim 1, further comprising the step of making a recommendation to the identified passenger, wherein the recommendation includes the determined available seat on the mass transit transporter for the route.

3. The method of claim 1, wherein the step of identifying a mass transit passenger comprises the steps of:
receiving information from the mass transit passenger entering the station of the mass transit system, wherein the information is received from at least one of a mass transit system ticket, a travel reservation, or a mass transit system identification card; and
identifying, based on the received information, the passenger entering the station of the mass transit system.

4. The method of claim 1, wherein the step of determining a location of an exit station further comprises the steps of:
requesting itinerary information from the identified passenger; and
determining, based, at least in part, on the itinerary information, the exit station.

5. The method of claim 1, wherein the step of determining an available seat on the mass transit transporter for the route further comprises:
determining, based, at least in part, on passenger information for the identified passenger received from a mass transit system identification card, whether the identified passenger requires a special seat;
in response to determining the identified passenger requires the special seat, determining an available special seat; and
making a recommendation to the identified passenger, wherein the recommendation includes the determined available special seat.

6. The method of claim 5, wherein the special seat includes at least one of a bicycle passenger seat and a stroller accessible seat.

7. (canceled)

8. A computer program product for managing mass transit system passengers, the computer program product comprising:
one or more computer-readable storage media and program instructions stored on the one or more computer-readable storage media, the program instructions comprising:
program instructions to identify, by a computing system, a mass transit passenger entering a station of a mass transit system;
program instructions to identify, by the computing system, an entry time and day, and a location of the station by the identified passenger is entering;
program instructions to retrieve historical data for the identified passenger;
program instructions to retrieve event information for the entry time and day, the event information including calendar and weather information;
program instructions to determine, for the identified passenger, based, at least in part, on at least one of the historical data and the event information, a location of an exit station;
program instructions to determine, for the identified passenger, a route between the location of the entered station and the location of the exit station; and
program instructions to determine, for the identified passenger, based, at least in part, on one or more of the entry time and day, the determined exit station, the historical data, the event information, and the determined route, an available seat on a mass transit transporter of the mass transit system for the route.

9. The computer program product of claim 8, further comprising program instructions to make a recommendation to the identified passenger, wherein the recommendation includes the determined available seat on the mass transit transporter for the route.

10. The computer program product of claim 8, wherein the program instructions to identify a mass transit passenger comprise:
program instructions to receive information from the mass transit passenger entering the station of the mass transit system, wherein the information is received from at least one of a mass transit system ticket, a travel reservation, or a mass transit system identification card; and
program instructions to identify, based on the received information, the passenger entering the station of the mass transit system.

11. The computer program product of claim 8, wherein the program instructions to determine a location of an exit station further comprise:
program instructions to request itinerary information from the identified passenger; and
program instructions to determine, based, at least in part, on the itinerary information, the exit station.

12. The computer program product of claim 8, wherein the program instructions to determine an available seat on the mass transit transporter for the route further comprise:
program instructions to determine, based, at least in part, on passenger information for the identified passenger received from a mass transit system identification card, whether the identified passenger requires a special seat;
in response to determining the identified passenger requires the special seat, program instructions to determine an available special seat; and
program instructions to make a recommendation to the identified passenger, wherein the recommendation includes the determined available special seat.

13. (canceled)

14. (canceled)

15. A computer system for managing mass transit system passengers, the computer system comprising:
one or more computer processors;
one or more computer-readable storage media;
program instructions stored on the one or more computer-readable storage media for execution by at least one of the one or more computer processors, the program instructions comprising:
program instructions to identify, by a computing system, a mass transit passenger entering a station of a mass transit system;
program instructions to identify, by the computing system, an entry time and day, and a location of the station the identified passenger is entering;
program instructions to retrieve historical data for the identified passenger;
program instructions to retrieve event information for the entry time and day, the event information including calendar and weather information;
program instructions to determine, for the identified passenger, based, at least in part, on at least one of the historical data and the event information, a location of an exit station;
program instructions to determine, for the identified passenger, a route between the location of the entered station and the location of the exit station; and
program instructions to determine, for the identified passenger, based, at least in part, on one or more of the entry time and day, the determined exit station, the historical data, the event information, and the determined route, an available seat on a mass transit transporter of the mass transit system for the route.

16. The computer system of claim 15, further comprising program instructions to make a recommendation to the identified passenger, wherein the recommendation includes the determined available seat on the mass transit transporter for the route.

17. The computer system of claim 15, wherein the program instructions to identify a mass transit passenger comprise:
program instructions to receive information from the mass transit passenger entering the station of the mass transit system, wherein the information is received from at least one of a mass transit system ticket, a travel reservation, or a mass transit system identification card; and
program instructions to identify, based on the received information, the passenger entering the station of the mass transit system.

18. The computer system of claim 15, wherein the program instructions to determine a location of an exit station further comprise:
program instructions to request itinerary information from the identified passenger; and
program instructions to determine, based, at least in part, on the itinerary information, the exit station.

19. The computer system of claim 15, wherein the program instructions to determine an available seat on the mass transit transporter for the route further comprise:
program instructions to determine, based, at least in part, on passenger information for the identified passenger received from a mass transit system identification card, whether the identified passenger requires a special seat, wherein a special seat includes at least one of a bicycle passenger seat and a stroller accessible seat;
in response to determining the identified passenger requires the special seat, program instructions to determine an available special seat; and
program instructions to make a recommendation to the identified passenger, wherein the recommendation includes the determined available special seat.

20. (canceled)

21. The method of claim 2, wherein making the recommendation further comprises sending the recommendation to a mobile computing device of the identified passenger.

22. The computer program product of claim 9, wherein the program instructions to make the recommendation further comprise program instructions to send the recommendation to a mobile computing device of the identified passenger.

23. The computer system of claim 16, wherein the program instructions to make the recommendation further comprise program instructions to send the recommendation to a mobile computing device of the identified passenger.

24. The method of claim 1, further comprising:
determining, by the computing system, a second mass transit passenger entering a station of the mass transit system;
identifying, by the computing system, an entry time and day, and a location of the station the second mass transit passenger is entering; and
determining, by the computing system, based, at least in part, on event information, including calendar information and weather information, a location of an exit station for the second mass transit passenger.
